(19) United States
(12) Patent Application Publication
(10) Pub. No.: US 2026/0341972 A1
(43) Pub. Date: Oct. 29, 2026

(54) TRANSMISSION USING A HOLOGRAPHIC MIMO SURFACE HAVING MULTIPLE SIGNAL FEEDERS

(71) Applicant: QUALCOMM Incorporated, San Diego, CA (US)

(72) Inventors: Wei XI, Beijing (CN); Min HUANG, Beijing (CN); Chao WEI, Beijing (CN); Hao XU, Beijing (CN)

(21) Appl. No.: 19/485,355

(22) PCT Filed: Jun. 22, 2023
(86) PCT No.: PCT/CN2023/101990

§ 371 Date: Nov. 18, 2025

(51) Int. Cl. H01Q 19/06; H01Q 21/00

(52) U.S. Cl. CPC H01Q 19/067; H01Q 21/00

(57) ABSTRACT

A holographic surface transmission scheme selection method includes: obtaining, at an apparatus, a desired signal direction relative to one or more holographic surfaces, comprising a plurality of antenna elements, of the apparatus; and transmitting, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Wireless communication systems, especially beyond 5G wireless communication systems, e.g., sixth-generation (6G) systems and beyond, may support large quantities (often referred to as massive numbers or massive quantities) of end users. To support such quantities of end users, beam-forming techniques may be very useful. Holographic MIMO (holographic multiple input multiple output, i.e., HMIMO) surfaces may be used to provide beam-formed communications, e.g., beam-formed transmissions. Holographic MIMO surfaces may be low cost, small in size, have low weight, and low power consumption.

### SUMMARY

An example an apparatus includes: one or more memories; one or more transmitters including: one or more holographic surfaces comprising a plurality of antenna elements; at least one signal source; and a plurality of energy couplers each coupled to one of the at least one signal source and each coupled to a respective location of the one or more holographic surfaces; and one or more processors communicatively coupled to the one or more memories and the one or more transmitters and configured to: obtain a desired signal direction relative to the one or more holographic surfaces; and cause the one or more holographic surfaces to emit, based on the desired signal direction and a layout of the plurality of energy couplers relative to the one or more holographic surfaces, toward the desired signal direction one or more transmit signals either from a combination of energy couplers of the plurality of energy couplers, or from a selected one of the plurality of energy couplers.

An example holographic surface transmission scheme selection method includes: obtaining, at an apparatus, a desired signal direction relative to one or more holographic surfaces, comprising a plurality of antenna elements, of the apparatus; and transmitting, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers.

Another example apparatus includes: means for obtaining a desired signal direction relative to one or more holographic surfaces, comprising a plurality of antenna elements, of the apparatus; and means for transmitting, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers.

An example non-transitory, processor-readable storage medium includes processor-readable instructions to cause one or more processors of an apparatus to: obtain a desired signal direction relative to one or more holographic surfaces, comprising a plurality of antenna elements, of the apparatus; and transmit, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers.

### BRIEF DESCRIPTION OF THE DRAWINGS

FIG. 1 is a block diagram of holographic reconstruction using optical signals.

FIG. 2 is a block diagram of holographic beamforming using radio signals.

FIG. 3 is a block diagram of a linear antenna array.

FIG. 4 is a block diagram of components of a holographic MIMO surface.

FIG. 5 is a block diagram of an example apparatus including a holographic surface.

FIG. 6 is a perspective view of an antenna element of a holographic surface.

FIG. 7 is a diagram of a one-dimensional holographic surface with two feeders at arbitrary locations.

FIG. 8 is a block flow diagram of transmission scheme selection, inter-feeder precoder selection, and feeder selection for selective-feeder transmission.

FIG. 9 is a diagram of a one-dimensional holographic surface with two feeders at opposite ends of the surface.

FIG. 10 is a diagram of a one-dimensional holographic surface with two feeders near a middle of the surface.

FIG. 11 is a diagram of a one-dimensional holographic surface with four feeders, with two feeders at opposite ends of the surface and two feeders near a middle of the surface.

FIG. 12 is a block flow diagram of a holographic surface transmission scheme selection method.

### DETAILED DESCRIPTION

Techniques are discussed herein for transmitting signals from a holographic MIMO (Multiple Input Multiple Output) surface that has multiple signal feeders. For example, a decision may be made whether to transmit signals concurrently from multiple feeders and apply inter-feeder precoding to the feeders, or to use selective-feeder transmission (to select a single feeder of the multiple feeders) for providing one or more transmit signals to the HMS (Holographic MIMO Surface). Inter-feeder precoding or selective-feeder transmission may be selected based on which technique results in more active antenna elements of the HMS. Inter-feeder precoders may be determined based on inter-feeder distances (separations of the feeders). In selective-feeder transmission, the feeder that results in a higher number of active elements of the HMS may be selected. Other configurations, however, may be used.

Items and/or techniques described herein may provide one or more of the following capabilities, as well as other capabilities not mentioned. A transmission scheme (inter-feeder precoding or selective-feeder transmission) that results in larger beamforming gain may be selected. With inter-feeder precoding, signal components from multiple feeders can be constructively combined at each active element such that larger beamforming gain may be achieved. For selective-feeder transmission, an appropriate feeder may be selected based on available active elements (e.g., to maximize available active elements) to help ensure that maximum available beamforming gain is realized. For selective-feeder transmission, higher radiation power in the target direction may be achieved. Other capabilities may be provided and not every implementation according to the disclosure must provide any, let alone all, of the capabilities discussed.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

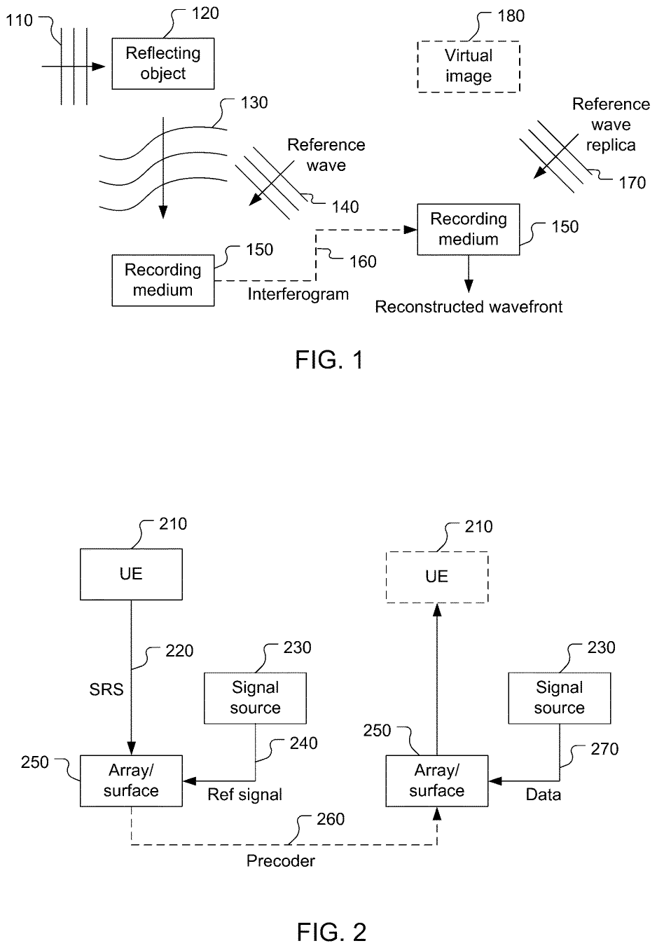

Referring to FIG. 1, an HMIMO (Holographic MIMO) surface may be used to produce a holographic interferogram and for holographic reconstruction in optical applications. For example, in an optical application as shown in FIG. 1, an illuminating wave 110 may be incident on a reflecting object 120 that reflects a corresponding reflected wave 130 to a recording medium 150, comprising an HMIMO surface. The recording medium 150 may store a holographic interferogram 160 corresponding to a difference between the reflected wave 130 (which may be called an object wave) and a reference wave 140. The interferogram 160 may be added to a reference wave replica 170 (a replica of the reference wave 140) by the recording medium 150 to determine a virtual image 180 of the reflecting object 120. The recording medium 150 may provide a virtual image 180 such that the recording medium acts as a holographic display.

Referring to FIG. 2, similar to the optical application shown in FIG. 1, an HMIMO surface may be used for radio signal acquisition and holographic beamforming in radio applications. A user equipment (UE) 210 may transmit a wireless signal 220 (in this example, a Sounding Reference Signal (SRS)) to an HMIMO array/surface 250. The HMIMO array/surface 250 may receive the wireless signal 220 and a reference signal 240 (e.g., a Radio Frequency (RF) signal) from a signal source 230. The wireless signal 220 (object wave) and the reference signal 240 are mixed/multiplied at each antenna element of the HMIMO array/surface 250. The HMIMO array/surface 250 may comprise an array of transmit/receive elements and may be configured to determine a precoder 260 corresponding to a state of a channel between the UE 210 and the HMIMO array/surface based on the wireless signal 220 and the reference signal 240. The HMIMO array/surface 250 may use the precoder 260 to transmit a data signal 270 (e.g., a reference signal modulated with a data signal) from the signal source 230. By transmitting the data signal 270 in accordance with the precoder 260, the HMIMO array/surface beamforms the data signal 270 such that the data signal 270 is transmitted to the UE 210 (or at least toward a direction of where the UE 210 was when the UE 210 transmitted the wireless signal 220).

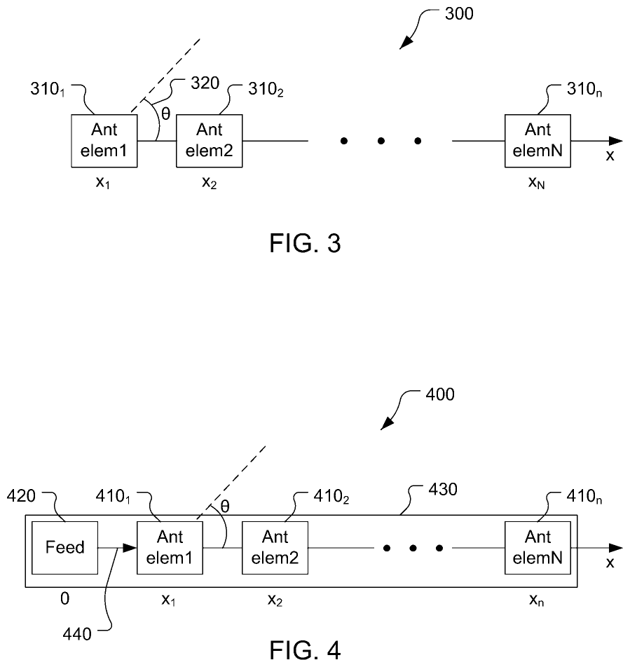

Referring to FIG. 3, an HMIMO surface 300 includes an array of antenna elements 310₁, 310₂, . . . , 310_{N}. In this example, the array is a uniform linear array (ULA) of the antenna elements 310₁-310_{N}. A signal may be provided to the antenna elements 310₁-310_{N} such that there is a linear phase gradient at the antenna elements 310₁-310_{N}. For example, in order to direct a transmitted signal at an angle 320 of θ°, the phase at the n^{th} antenna element of the antenna elements 310₁-310_{N} may be given by

$${Φ}_{n} = {e}^{- j \frac{2 π}{{λ}_{f}} {x}_{n} cos θ} \qquad ( 1 )$$

where Φₙ is the phase at the n^{th} antenna element, xₙ is the location of the n^{th} antenna element (here, along the x-axis), and λ_{f} is the wavelength of the transmitted signal in free space. The different phases may be applied to the different antenna elements 310₁-310_{N} in parallel using phase shifters (not shown) or by using progressive feeding with a phase at each antenna element being a function of distance of the antenna element from a signal feed location.

Referring to FIG. 4, an HMIMO surface 400 includes an array of antenna elements 410₁, 410₂, . . . , 410_{N} fed by a signal feed 420 and disposed in a substrate 430. The signal feed 420 may transmit a reference signal 440 (also called a reference wave) into the substrate 430 such that the reference signal 440 propagates in the substrate 430, which acts as a waveguide, to each of the antenna elements 410₁, 410₂, . . . , 410_{N}, reaching the antenna elements 410₁, 410₂, . . . , 410_{N} with respective phases. The reference signal propagating in the substrate 430 forms a fully-connected radio distribution network (RDN) for antenna virtualization. A phase of the reference signal 440 as a function of location in the array (along the x-axis in this example) is given by

$${Φ}_{ref - n} = {e}^{- j \frac{2 π}{{λ}_{s}} {x}_{n}} \qquad ( 2 )$$

where Pref-n is the phase of the reference signal 440 at the n^{th} antenna element, xₙ is the location of the n^{th} antenna element (here, along the x-axis), and λs is the wavelength of the transmitted signal in the substrate 430. With the phase of the object wave (e.g., the wireless signal 220 shown in FIG. 2) given by Equation (1), an interferogram precoder of the object-reference waves is given by

$$precoder = {e}^{j 2 π {x}_{n}} ( \frac{1}{{λ}_{s}} - \frac{cos θ}{{λ}_{f}} ) \qquad ( 3 )$$

The HMIMO surface 400 may include more antenna elements than are desired to radiate. Only the antenna elements where the phase of the precoder is at least close to 0° (e.g., with an absolute value of phase being less than 10°, less than 20°, less than 45°, or less than 90°) are allowed to leak/radiate. For example, for amplitude-controllable antenna elements (e.g., PIN diodes (p-type, intrinsic semiconductor, n-type diodes), varactors, liquid crystal elements, etc.), only the antenna elements (called active antenna elements) with in-phase (or nearly in-phase) object-reference waves are allowed (e.g., activated) to leak (or radiate strongly) electromagnetic (EM) energy from the reference signal 440 to free space. Other antenna elements of the antenna elements 410₁, 410₂, . . . , 410_{N} may be shielded (or radiate weakly) and thus may be called inactive elements.

Various apparatus, such as a base station or UE, may be configured to provide beamforming based on an HMIMO surface (HMS). For example, a base station or UE may be configured to adapt to multiple signal feeders, may be configured to perform inter-feeder precoding, and/or may be configured to determine whether to transmit from multiple signal feeders (or perhaps a single signal feeder).

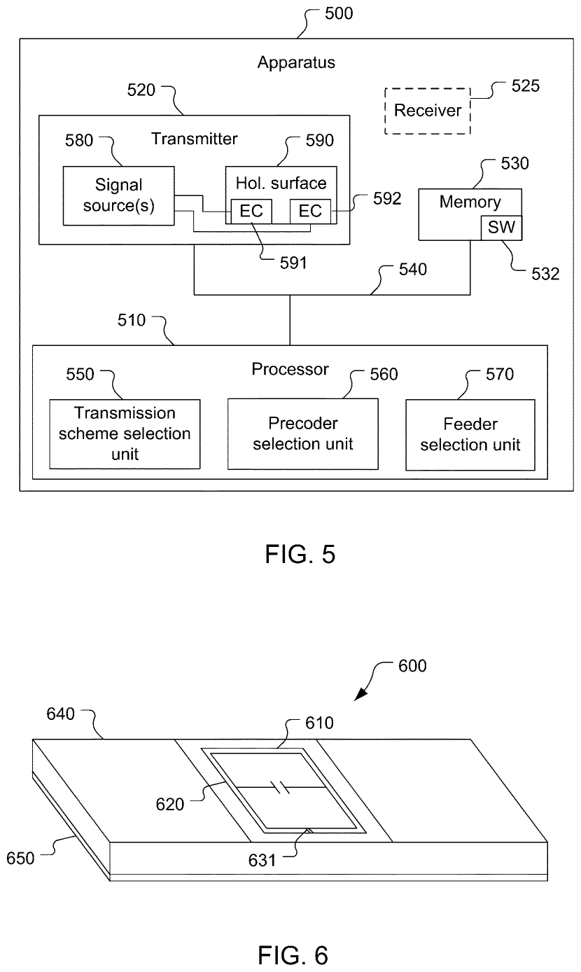

Referring also to FIG. 5, an example of an apparatus 500 comprises a computing platform including a processor 510, a transmitter 520, and a memory 530 including software (SW) 532. Even if referred to in the singular, the processor 510 may include one or more processors, the transmitter 520 may include one or more transceivers (e.g., one or more transmitters and/or one or more receivers), and the memory 530 may include one or more memories. The apparatus 500 may be any of a variety of devices, e.g., a UE, a transmission/reception point (TRP) (e.g., a base station such as a cellular communication base station, e.g., a gNB), etc. The processor 510, the transmitter 520, and the memory 530 may be communicatively coupled to each other by a bus 540 (which may be configured, e.g., for optical and/or electrical communication). One or more of the shown apparatus (e.g., a wireless transceiver) may be omitted from the apparatus 500. The processor 510 may include one or more intelligent hardware devices, e.g., a central processing unit (CPU), a microcontroller, an application specific integrated circuit (ASIC), etc. The processor 510 may comprise multiple processors (e.g., including a general-purpose/application processor, a DSP, a modem processor, a video processor, and/or a sensor processor). The memory 530 may be a non-transitory storage medium that may include random access memory (RAM)), flash memory, disc memory, and/or read-only memory (ROM), etc. The memory 530 may store the software 532 which may be processor-readable, processor-executable software code containing instructions that are configured to, when executed, cause the processor 510 to perform various functions described herein. Alternatively, the software 532 may not be directly executable by the processor 510 but may be configured to cause the processor 510, e.g., when compiled and executed, to perform the functions. The processor 510 may include a memory with stored instructions in addition to and/or instead of the memory 530. Even if referred to in the singular, including in the claims, the processor 510 may include one or more processors, the transmitter 520 may include one or more transmitters (e.g., one or more transmitters), and the memory 530 may include one or more memories.

The transmitter 520 may include one or more signal sources 580, a holographic surface 590 for transmitting (e.g., on one or more uplink channels and/or one or more sidelink channels) wireless signals. Even if referred to in the singular, the holographic surface 590 (or other holographic surface) may include one or more holographic surfaces. The holographic surface 590 includes multiple energy couplers, in this example, energy couplers 591, 592 (although other quantities of energy couplers may be used, e.g., as discussed herein). The signal source(s) 580 may include multiple transmitters that may be discrete components or combined/integrated components and/or the holographic surface 590 may comprise multiple antennas. The signal source(s) 580 may be configured to communicate signals (e.g., with one or more UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc.

The configuration of the apparatus 500 shown in FIG. 5 is an example and not limiting of the disclosure, including the claims, and other configurations may be used.

The description herein may refer to the processor 510 performing a function, but this includes other implementations such as where the processor 510 executes software (stored in the memory 530) and/or firmware. The description herein may refer to the apparatus 500 performing a function as shorthand for one or more appropriate components (e.g., the processor 510 and the memory 530) of the apparatus 500 performing the function. The processor 510 (possibly in conjunction with the memory 530 and, as appropriate, the transmitter 520) may include a transmission scheme selection unit 550, a precoder selection unit 560, and/or a feeder selection unit 570. The transmission scheme selection unit 550 may be configured to determine whether to implement inter-feeder precoding or selective feeder transmission. The precoder selection unit 560 may be configured to select a precoder for inter-feeder precoding. The feeder selection unit 570 may be configured to select one or more feeders for signal transmission. The transmission scheme selection unit 550, the precoder selection unit 560, and the feeder selection unit 570 are discussed further below, and the description may refer to the processor 510 generally, or the apparatus 500 generally, as performing any of the functions of the transmission scheme selection unit 550, the precoder selection unit 560, and the feeder selection unit 570, with the apparatus 500 being configured to perform the function(s).

Referring also to FIG. 6, the holographic surface 590 may comprise an HMS that includes multiple (e.g., a one-dimensional or two-dimensional array of) antenna elements such as an antenna element 600. The antenna element 600 includes a loop radiator 610 comprising a microstrip line 620, a PIN diode 631, a dielectric layer 640, and a ground conductor 650. The antenna element 600 in this example is a cELC (complementary electric-LC (inductor/capacitor)) resonator. The PIN diode 631 may be communicatively coupled to the processor 510 and controlled by the processor to be either in an ON state or an OFF state, with the antenna element 600 radiating significantly more with the PIN diode 631 in the OFF state than with the PIN diode 631 in the ON state. The dielectric layer 640 in combination with the ground conductor 650 provides a waveguide to guide a transmit signal (also called a transmission signal) in the dielectric layer 640 to different antenna elements 600 that may radiate the transmit signal significantly (e.g., with 30% efficiency or more), or may pass the transmit signal without radiating (or radiating very weakly, e.g., with 15% efficiency or less) along the dielectric layer 640 to a next antenna element. Even if referred to in the singular, the transmit signal may comprise one or more transmit signals.

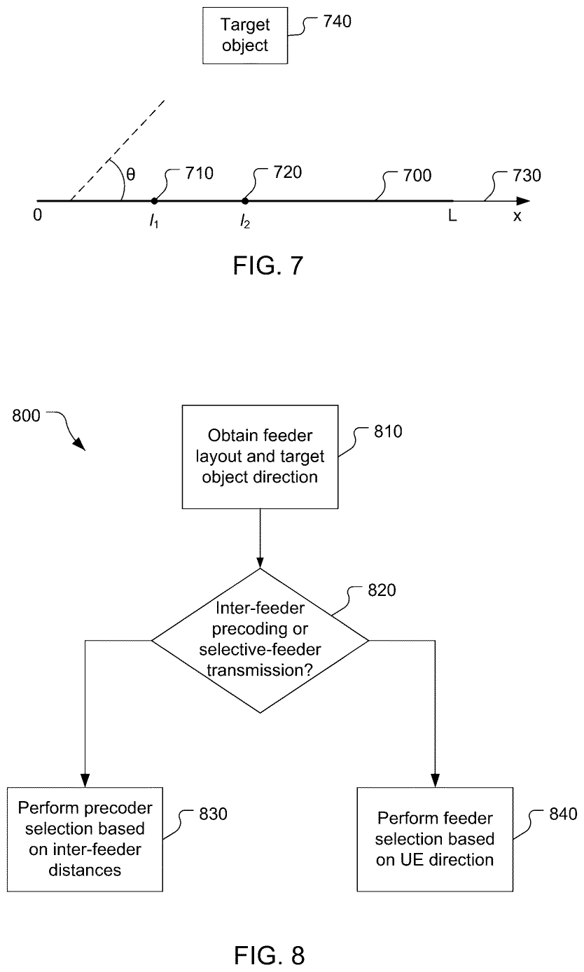

Referring also to FIG. 7, the processor 510 may be configured to determine a transmission scheme to use, select antenna elements to activate, and to determine and apply precoders to transmit signals for various situations of multiple signal feeders. As shown in the example of FIG. 7, a one-dimensional HMS 700 (HMIMO surface) (e.g., the holographic surface 590) has a length L and includes signal feeders 710, 720 (e.g., the energy couplers 591, 592) disposed at locations (l₁, 0) and (l₂, 0), respectively, along an x-axis 730 where, 0≤l₁≤l₂≤L. A target object 740 (e.g., a UE) may be disposed at an angle θ in the far field relative to the HMS 700, where θ∈[0, π]. The expected outcome for precoding in this example may be given by

$${h}_{θ} ( x ) = {e}^{j \frac{2 π}{{λ}_{f}} x c o s θ} \qquad ( 4 )$$

where h_{θ}(x) is the phase at location x along the x-axis 730, where x∈[0, L], and λ_{f} is the wavelength of the transmitted signal in free space. A wavelength λₛ of the transmitted signal in the dielectric layer 640 (in the HMS (waveguide)) will be less than the wavelength λ_{f} of the transmitted signal in free space (i.e., λₛ<λ_{f}) if a dielectric constant of the dielectric layer 640 is greater than 1

$$( e . g . , \frac{{λ}_{f}}{{λ}_{s}} = \sqrt{3} ) .$$

The signal feeders 710, 720 may transmit signals s₁, s₂, respectively. A precoder for feeder i may be provided by

$${w}_{i} ( x ) = {e}^{- j \frac{2 π}{{λ}_{s}} \vert x - {l}_{i} \vert} , x ∈ [ 0 , L ] \qquad ( 5 )$$

where i=1, 2. Which antenna elements to activate may be determined based on concurrent transmission of the signals s₁, s₂. Antenna elements desired to be active may differ if the antenna elements to activate are determined separately for transmission of the signals s₁, s₂ at separate times. With the signals s₁, s₂ transmitted concurrently by the feeders 710, 720, the signals s₁, s₂ may be combined constructively at each active antenna element such that

$${s}_{1} {w}_{1} ( x ) + {s}_{2} {w}_{2} ( x ) = \{ \begin{matrix}\begin{matrix}{e}^{j \frac{2 π}{{λ}_{s}} x} ( {s}_{1} {e}^{- j \frac{2 π}{{λ}_{s}} {l}_{1}} + {s}_{2} {e}^{- j \frac{2 π}{{λ}_{s}} {l}_{2}} ) , \\ x ∈ [ 0 , {l}_{1} ] ;\end{matrix} \\ \begin{matrix}{s}_{1} {e}^{j \frac{2 π}{{λ}_{s}} {l}_{1}} {e}^{- j \frac{2 π}{{λ}_{s}} x} + {s}_{2} {e}^{- j \frac{2 π}{{λ}_{s}} {l}_{2}} {e}^{j \frac{2 π}{{λ}_{s}} x} , \\ x ∈ [ {l}_{1} , {l}_{2} ] ;\end{matrix} \\ \begin{matrix}{e}^{- j \frac{2 π}{{λ}_{s}} x} ( {s}_{1} {e}^{j \frac{2 π}{{λ}_{s}} {l}_{1}} + {s}_{2} {e}^{j \frac{2 π}{{λ}_{s}} {l}_{2}} ) , \\ x ∈ [ {l}_{2} , L ]\end{matrix}\end{matrix} . \qquad ( 6 )$$

For outer antenna elements (i.e., x∈[0, l₁]∪[l₂, L]), inter-feeder precoding is preferred because inter-feeder precoding has been found to provide better gain than selective-feeder transmission for outer antenna elements. For inner elements (i.e., x∈[l₁, l₂], feeder selection (i.e., selective-feeder transmission, i.e., transmission by one of the feeders 710, 720 at a time) is preferred.

Referring to FIG. 8, with further reference to FIGS. 1-7, a method 800 for HMS transmission scheme selection and configuration includes the stages shown. The method 800 is, however, an example only and not limiting. The method 800 may be altered, e.g., by having one or more stages added, removed, rearranged, combined, performed concurrently, and/or by having one or more single stages split into multiple stages.

At stage 810, the method 800 includes obtaining a feeder layout and a target object direction. For example, the processor 510 may retrieve a feeder layout (e.g., quantity of feeders and location for each feeder) from the memory 530, with the memory being programmed with the feeder layout. As another example, the processor 510 may communicate with an antenna module containing the holographic surface 590 to determine the feeder layout (e.g., by requesting the layout, and receiving the layout, from the antenna module). The target object direction may be determined in any of a variety of manners. For example, the apparatus 500 may measure one or more signals (e.g., SRS) transmitted by the target object 740 and determine an angle of arrival (AoA) of the signal(s) transmitted by the target object 740. As another example, the target object 740 may select and report a preferred reference signal resource/port/feeder, e.g., based on measurement by the target object 740 of one or more signals (e.g., CSI-RS (Channel State Information-Reference Signal)) transmitted by the apparatus 500. The apparatus 500 may use the reported preferred reference signal resource/port/feeder to determine the angle corresponding to the target object direction, e.g., the angle θ shown in FIG. 7. The angle θ shown in FIG. 7 comprises a zenith angle only, but an angle that includes both azimuth and zenith components may be determined for a two-dimensional HMS.

At stage 820, the processor 510 may determine whether to implement inter-feeder precoding or selective feeder transmission for transmitting a signal to the target object. Inter-feeder precoding comprises transmitting a signal from an HMS as a combination of signals from a combination of multiple feeders with one or more corresponding precoders. Selective feeder transmission comprises selecting one of multiple feeders and transmitting a signal from the selected one of the feeders from an HMS to the target object.

The processor 510, e.g., the transmission scheme selection unit 550, may calculate quantities of active antenna elements, one quantity corresponding to each transmission scheme, based on the angle θ, compare the quantities, and select the transmission scheme corresponding to the higher quantity. For example, for the one-dimensional HMS 700 of length L, and the feeders 710, 720 at locations (l₁, 0) and (l₂, 0), respectively, along the x-axis 730 where, 0≤l₁≤l₂≤L, quantities of active antenna elements may be determined according to

$${N}_{i f p} = ⌊ \frac{L + {l}_{1} - {l}_{2}}{{λ}_{s}} + \frac{( {l}_{1} + {l}_{2} - L ) cos θ}{{λ}_{f}} ⌋ \qquad ( 7 )$$

$${N}_{s f , i} = ⌊ \frac{L}{{λ}_{s}} + \frac{( 2 {l}_{i} - L ) cos θ}{{λ}_{f}} ⌋ , i = 1 , 2 \qquad ( 8 )$$

where N_{ifp} is the number of active elements for inter-feeder precoding (ifp), N_{sf,i} is the number of active elements for selective-feeder (sf) transmission for feeder i, and θ is the direction from the HMS 700 to the target object 740 (i.e., the target object direction). Alternatively, the processor 510, e.g., the transmission scheme selection unit 550, may obtain the quantities of active antenna elements from the memory 530, e.g., from a look-up table, given the values of the length L, the locations (l₁, 0) and (l₂, 0), and the wavelengths. For a given target object direction, if

2N_{ifp}>max{N_{fs,1},N_{fs,2}} (9)

then the transmission scheme selection unit 550 will determine to use inter-feeder precoding for signal transmission to the target object 740. Else, i.e., if the inequality (9) is not true (e.g., 2N_{ifp}<max{N_{fs,1}, N_{fs,2}} or 2N_{ifp}≤max{N_{fs,1}, N_{fs,2}}), then the transmission scheme selection unit 550 will determine to use selective-feeder transmission for signal transmission to the target object 740. For selective-feeder transmission, if

N_{fs,1}≥N_{fs,2} (10)

then the transmission scheme selection unit 550 will determine to use feeder 1, here the feeder 710, and otherwise will determine to use feeder 2, here the feeder 720. Other quantities of feeders could be used. For example, if three feeders are used, then if

3N_{ifp}>max{N_{fs,1},N_{fs,2}} (11)

then the transmission scheme selection unit 550 will determine to use inter-feeder precoding for signal transmission to the target object 740. Else, i.e., if the inequality (11) is not true, then the transmission scheme selection unit 550 will determine to use selective-feeder transmission for signal transmission to the target object 740.

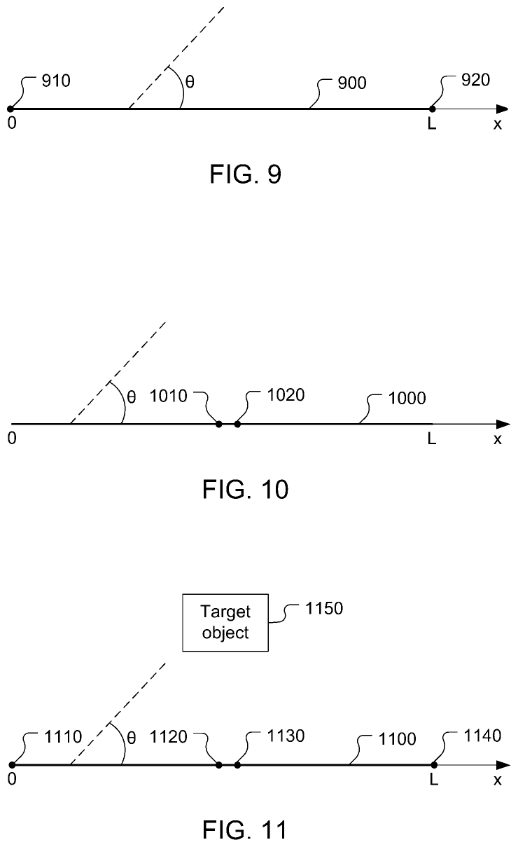

Referring also to FIGS. 9 and 10, two feeder layouts for using two feeders are to have the feeders, here feeders 910, 920, disposed at opposite ends of the HMS 900 or to have the feeders 1010, 1020 disposed close to each other, typically near the middle of an HMS 1000. For the feeder layout with the feeders 910, 920 disposed at opposite ends of the HMS 900, i.e., l₁=0 and l₂=L, as shown in FIG. 9, the transmission scheme selection unit 550 will determine to use selective-feeder transmission. For a feeder layout with feeders 1010, 1020 disposed in an HMS 1000 close to each other, e.g., separated by λs or λₛ/2, as shown in FIG. 10, the transmission scheme selection unit 550 will determine to use inter-feeder precoding. In such configurations, the blocks 810 and 820 may not be performed during operation of the device or may be performed only once, e.g., at startup or upon initialization. In some such configurations, whether to use selective-feed transmission or inter-feeder precoding may be substantially permanently stored or may be coded into instructions for the transmitter 520 such that a determination of which scheme to use need not be performed.

Referring also to FIG. 11, a feeder layout includes four feeders 1110, 1120, 1130, 1140. The feeders 1120, 1130 are disposed in close proximity (e.g., a multiple of λₛ/2) to each other and near a middle of (e.g., centered with respect to) a holographic surface 1100, e.g., at locations l₂=L/2 and l₃=(L+2λₛ)/2. The feeders 1110, 1140 are disposed at opposite ends of the surface 1100, e.g., at locations l₁=0 and l₄=L. In this configuration, the transmission scheme selection unit 550 may switch, based on the target object direction θ, between selecting inter-feeder precoding using the inner feeders, here the feeders 1120, 1130, and inter-feeder transmission using one of the outer feeders, here the feeders 1110, 1140. For inter-feeder precoding based on the feeders 1120, 1130, the number of active elements is given by

$${N}_{i f p} = ⌊ \frac{L}{{λ}_{s}} - \frac{1}{2} + \frac{{λ}_{s} cos θ}{2 {λ}_{f}} ⌋ \qquad ( 12 )$$

For selective-feeder transmission, the number of active elements is given by

$${N}_{fs , 1} = ⌊ \frac{L}{{λ}_{s}} - \frac{L cos θ}{{λ}_{f}} ⌋ \qquad ( 13 )$$

$${N}_{f s , 4} = ⌊ \frac{L}{{λ}_{s}} + \frac{L cos θ}{{λ}_{f}} ⌋ \qquad ( 14 )$$

where N_{fs,1} is the number of active elements if the feeder 1110 is used to transmit a signal and N_{fs,4} is the number of active elements if the feeder 1140 is used to transmit a signal. With a target object 1150 located at a target object direction θ relative to the surface 1100, if

2N_{ifp}>max{N_{fs,1},N_{fs,4}} (15)

then the transmission scheme selection unit 550 will select inter-feeder precoding based on the feeders 1120, 1130 and otherwise will select selective-feeder transmission using the feeder 1110 or the feeder 1140. If

N_{fs,1}≥N_{fs,4} (16)

then the transmission scheme selection unit 550 will select the feeder 1110 and otherwise will select the feeder 1140. The quantity and/or location of feeders may be different than illustrated. For example, one of the feeders 1110, 1140 may be omitted and/or there may be a greater quantity of feeders in the middle (e.g., including three, four, or more feeders).

Once the transmission scheme selection unit 550 determines at stage 820 to implement inter-feeder precoding, the method 800 proceeds from stage 820 to stage 830. At stage 830, the precoder selection unit 560 may determine a precoder for each of the energy couplers 591, 592 (and other feeders as appropriate).

The precoder selection unit 560 may determine a precoding codebook for the feeders based on inter-feeder distances. For example, for the one-dimensional HMS 700 with the two feeders 710, 720, disposed at locations l₁, l₂, the precoder selection unit 560 may determine the codebook, C, as

$${C}_{2 - feeder} = \{ \begin{matrix}\frac{1}{\sqrt{2}} [ \begin{matrix}1 \\ {e}^{j \frac{2 π}{{λ}_{s}} ( {l}_{2} - {l}_{1} )}\end{matrix} ] , & x ∈ [ 0 , {l}_{1} ) ; \\ \frac{1}{\sqrt{2}} [ \begin{matrix}1 \\ {e}^{j \frac{2 π}{{λ}_{s}} ( {l}_{2} - {l}_{1} )}\end{matrix} ] , & x ∈ [ {l}_{2} , L )\end{matrix} . \qquad ( 17 )$$

If the inter-feeder distance, l₂−l₁, is (λₛ)/2, then the precoder becomes

$${C}_{2 - feeder} = \frac{1}{\sqrt{2}} [ \begin{matrix}1 \\ - 1\end{matrix} ] , i . e . , {s}_{1} = \frac{s}{\sqrt{2}} and {s}_{2} = - \frac{s}{\sqrt{2}} \qquad ( 18 )$$

Where s is a data symbol and sᵢ is the signal (data symbol multiplied by feeder-specific precoder) transmitted by feeder i. If the inter-feeder distance, l₂−l₁, is λₛ, then the precoder becomes

$${C}_{2 - feeder} = \frac{1}{\sqrt{2}} [ \begin{matrix}1 \\ 1\end{matrix} ] , i . e . , {s}_{1} = {s}_{2} = \frac{s}{\sqrt{2}} \qquad ( 19 )$$

The precoders in these cases are not functions of the target object direction θ because the feeder separation causes signal phases to differ by a factor of 2π.

The structure of an HMS with feeders may be extended to more than two feeders. For example, for a three-feeder configuration with feeders at locations l₁, l₂, l₃, the precoder may be represented as

$${C}_{3 - feeder} = \{ \begin{matrix}\frac{1}{\sqrt{3}} [ \begin{matrix}\begin{matrix}1 \\ {e}^{j \frac{2 π}{{λ}_{s}} ( {l}_{2} - {l}_{1} )}\end{matrix} \\ {e}^{j \frac{2 π}{{λ}_{s}} ( {l}_{3} - {l}_{1} )}\end{matrix} ] , x ∈ [ 0 , {l}_{1} ) ; \\ \frac{1}{\sqrt{3}} [ \begin{matrix}\begin{matrix}1 \\ {e}^{j \frac{2 π}{{λ}_{s}} ( {l}_{2} - {l}_{3} )}\end{matrix} \\ {e}^{j \frac{2 π}{{λ}_{s}} ( {l}_{1} - {l}_{3} )}\end{matrix} ] , x ∈ ( {l}_{3} , L ] ; \\ \frac{1}{\sqrt{2}} [ \begin{matrix}\begin{matrix}0 \\ 1\end{matrix} \\ {e}^{j \frac{2 π}{{λ}_{s}} ( {l}_{2} - {l}_{3} )}\end{matrix} ] , x ∈ ( {l}_{3} , L ] ; \\ \frac{1}{\sqrt{2}} [ \begin{matrix}\begin{matrix}0 \\ 1\end{matrix} \\ {e}^{j \frac{2 π}{{λ}_{s}} ( {l}_{3} - {l}_{2} )}\end{matrix} ] , x ∈ [ 0 , {l}_{2} ) ; \\ \frac{1}{\sqrt{2}} [ \begin{matrix}\begin{matrix}1 \\ {e}^{j \frac{2 π}{{λ}_{s}} ( {l}_{2} - {l}_{1} )}\end{matrix} \\ 0\end{matrix} ] , x ∈ [ 0 , {l}_{1} ) ; \\ \frac{1}{\sqrt{2}} [ \begin{matrix}\begin{matrix}1 \\ {e}^{j \frac{2 π}{{λ}_{s}} ( {l}_{1} - {l}_{2} )}\end{matrix} \\ 0\end{matrix} ] , x ∈ ( {l}_{2} , L ]\end{matrix} . \qquad ( 20 )$$

The codebook comprises the codewords that will be multiplied by the signals at the respective feeders, e.g., the top codeword in the codebook matrix (e.g., of each of the six codebook matrixes shown in Equation (20)) is multiplied by the signal at the first feeder, the next lower (e.g., second) codeword in the codebook matrix is multiplied by the signal at the next (e.g., second) feeder, etc. Multiple feeders will be transmitting concurrently, although a precoder of “0” indicates that the corresponding feeder will not be transmitting (or will be transmitting a null signal). Thus, multiple codewords may correspond to the same range of x (e.g., the second and third codewords in Expression (20)) with different configurations of transmitting feeders (e.g., all three feeders transmitting for the second codeword while only the second and third feeders are transmitting for the third codeword). If the codewords are different for different ranges of x, and do not differ by a multiple of π or 2π, then antenna elements in only one of such ranges will be activated. To enable antenna elements in multiple ranges concurrently, which helps improve gain (compared to not activating antenna elements in multiple ranges), the inter-feeder distances are selected/configured to be a multiple of λₛ/2 or λₛ such that codewords for the different ranges of x are the same or differ by a multiple of π or 2π.

Using inter-feeder precoding may increase beamforming gain compared to a single-feeder configuration. For a single feeder located at L/2, the precoder, effective channel, and beamforming gain are provided by

$$w ( x ) = {e}^{- j \frac{2 π}{{λ}_{s}} \vert x - \frac{L}{2} \vert} \qquad ( 21 )$$

$${h}_{e f f} ( {x}_{i} ) = {e}^{j \frac{π L cos θ}{{λ}_{f}}} \qquad ( 22 )$$

$$BF {G}_{s i n gle - feeder} = {\sum }_{i = 1}^{⌊ \frac{L}{{λ}_{s}} ⌋} {\vert {h}_{eff} ( {x}_{i} ) \vert}^{2} = {⌊ \frac{L}{{λ}_{s}} ⌋}^{2} \qquad ( 23 )$$

where w(x) is the precoder, h_{eff}(xᵢ) is the effective channel, and BFG is the beamforming gain. For a two-feeder configuration with feeders at locations l₂=L/2 and l₃=(L+λₛ)/2, the precoder, effective channel, and beamforming gain are provided by

$$w ( x ) = \frac{{e}^{- j \frac{2 π}{{λ}_{s}} \vert x - \frac{L}{2} \vert} - {e}^{- j \frac{2 π}{{λ}_{s}} \vert x - \frac{L + {λ}_{s}}{2} \vert}}{\sqrt{2}} \qquad ( 24 )$$

$${h}_{e f f} ( {x}_{i} ) = \sqrt{2} {e}^{j \frac{π Lcos θ}{{λ}_{f}}} \qquad ( 25 )$$

$$BF {G}_{2 - feeders} = {\sum }_{i = 1}^{⌊ \frac{L}{{λ}_{s}} ⌋} {\vert {h}_{eff} ( {x}_{i} ) \vert}^{2} = 2 {⌊ \frac{L}{{λ}_{s}} ⌋}^{2} \qquad ( 26 )$$

Thus, comparing Equations (23) and (26), the beamforming gain for the two-feeder configuration is twice the beamforming gain of the single-feeder configuration. In the two-feeder configuration with inter-feeder precoding, the locations x of active antenna elements is given by

$$0 , \frac{{λ}_{f} {λ}_{s}}{{λ}_{f} + {λ}_{s} cos θ} , \frac{2 {λ}_{f} {λ}_{s}}{{λ}_{f} + {λ}_{s} cos θ} , … , \frac{L}{2} , \frac{L}{2} + \frac{{λ}_{f} {λ}_{s}}{{λ}_{f} - {λ}_{s} cos θ} , … , L . \qquad ( 27 )$$

Referring again to FIG. 8, once the transmission scheme selection unit 550 determines at stage 820 to implement selective-feeder transmission, the method 800 proceeds from stage 820 to stage 840. At stage 830, the feeder selection unit 570 may determine a feeder with a larger number of active elements based on the target object direction θ (e.g., azimuth and/or zenith), which may provide larger beamforming gain and higher power efficiency.

For a feeder disposed at a location l along an HMS, the number of active elements of the HMS is given by Equation (8). For a feeder configuration as shown in FIG. 9, with the feeders 910, 920 disposed at opposite ends of the HMS 900, i.e., at locations l₁=0, l₂=L, the feeder selection unit 570 will select the feeders 910, 920 for target object directions as follows

$$feeder 910 ( i . e . , feeder at x = 0 ) for θ ∈ [ \frac{π}{2} , π ]$$

$$feeder 920 ( i . e . , feeder at x = L ) for θ ∈ [ 0 , \frac{π}{2} ] .$$

The apparatus 500 may estimate the target object direction θ in any of a variety of ways. For example, the apparatus 500 may include a receiver 525 (coupled to the bus 540) and the processor 510 may measure SRS transmitted by the target object 740 and determine AoA of the measured SRS. The receiver may include one or more antennas (e.g., sharing the holographic surface 590), may be a portion of a transceiver that includes the transmitter 520, and may be coupled to the bus 540. As another example, the target object may select and report a preferred port/feeder based on measurement of CSI-RS received at the target object 740. For example, if the apparatus 500 is a base station such as a gNB, a CSI-RS port may be transmitted by a feeder. As another example, the apparatus 500 may include an SPS (Satellite Positioning System) receiver (e.g., a combination of portions of the receiver 525, the memory 530, and the processor 510) and determine an estimated location of the apparatus 500 from received SPS signals. The processor 510 may receive an estimated location of the target object 740 (e.g., as reported by the target object 740) and determine the target object direction θ based on the location estimates of the apparatus 500 and the target object 740.

It has been found through simulations of a single-feeder system (with feeder located at (0, 0)) and a 2-feeder system (with feeders at (0, 0) and (L, 0)), with precoders given by Equation (5), that by selecting which feeder to use, alias beams are avoided and gain is as high or higher than for the single-feeder system. For example, the single-feeder system has an alias beam at about 137° when the beam is steered to θ=60°, but this alias beam may be avoided by selecting and using the feeder at (L, 0) for this target beam direction.

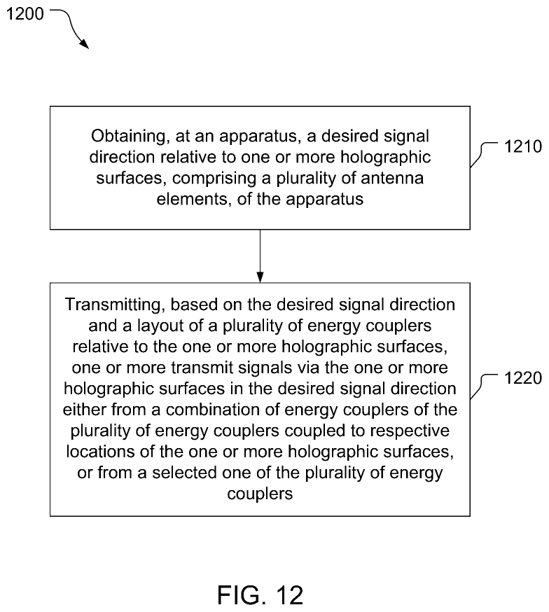

Referring to FIG. 12, with further reference to FIGS. 1-11, a holographic surface transmission scheme selection method 1200 includes the stages shown. The method 1200 is, however, an example only and not limiting. The method 1200 may be altered, e.g., by having one or more stages added, removed, rearranged, combined, performed concurrently, and/or by having one or more single stages split into multiple stages.

At stage 1210, the method 1200 includes obtaining, at an apparatus, a desired signal direction relative to one or more holographic surfaces, comprising a plurality of antenna elements, of the apparatus. For example, at stage 810, the processor 510 may obtain the target object direction. The processor 510, possibly in combination with the memory 530, possibly in combination with the receiver 525 may comprise means for obtaining the desired signal direction.

At stage 1220, the method 1200 includes transmitting, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers. For example, at stage 820 the transmission scheme selection unit 550 may determine whether to use inter-feeder precoding (with the one or more transmit signals formed from concurrent transmissions of respective signals from a combination of multiple feeders (e.g., the energy couplers 591, 592)), or selective-feeder transmission based on the target object direction and the feeder layout, e.g., as discussed above, e.g., with respect to Equations (7)-(11). The precoder selection unit 560 or the feeder selection unit 570 may select the appropriate feeder(s) and the appropriate precoder(s) and cause the feeder(s) and selectively activated antenna elements to form the one or more transmit signals transmitted by the holographic surface 590. The processor 510, possibly in combination with the memory 530, in combination with the transmitter 520 may comprise means for transmitting the one or more transmit signals.

Implementations of the method 1200 may include one or more of the following features. In an example implementation, the one or more transmit signals are transmitted either from the combination of energy couplers or from the selected one of the plurality of energy couplers based on which of the combination of energy couplers or the selected one of the plurality of energy couplers corresponds to a greater quantity of active antenna elements of the plurality of antenna elements. In a further example implementation, the method 1200 includes: determining a first quantity, corresponding to the combination of energy couplers including a first energy coupler of the plurality of energy couplers and a second energy coupler of the plurality of energy couplers, of active antenna elements of the plurality of antenna elements based on a length of an array of the plurality of antenna elements, a first location of a first connection of the first energy coupler to the one or more holographic surfaces, a second location of a second connection of the second energy coupler to the one or more holographic surfaces, the desired signal direction, a first wavelength of the one or more transmit signals in free space, and a second wavelength of the one or more transmit signals in the one or more holographic surfaces; determining a second quantity, corresponding to the selected one of the plurality of energy couplers, of active antenna elements of the plurality of antenna elements based on the length of the array of the plurality of antenna elements, the first location, the desired signal direction, the first wavelength of the one or more transmit signals in free space, and the second wavelength of the one or more transmit signals in the one or more holographic surfaces; and comparing the first quantity and the second quantity to determine whether to cause one or more transmitters of the apparatus to transmit the one or more transmit signals either from the combination of energy couplers or from the selected one of the plurality of energy couplers. For example, the processor 510 may determine quantities of active antenna elements according to Equations (7) and (8), make the comparison indicated by Expression (9), and determine whether to implement inter-feeder precoding or selective-feeder based on the result of the evaluation of Expression (9). For example, inter-feeder precoding may be used if Expression (9) is true and if the inequality (9) is not true (e.g., 2N_{ifp}<max{N_{fs,1}, N_{fs,2}} or 2N_{ifp}≤max{N_{fs,1}, N_{fs,2}}), then selective-feeder transmission may be used. For example, with feeders disposed at opposite ends of an array (e.g., as shown in FIG. 9), then selective-feeder transmission may be used and the feeder may be selected toward which the target object direction at least partially points (e.g., the feeder 920 for target object directions less than 90° and the feeder 910 for target object directions greater than 90°. Either feeder may be used for a neutral target object direction (e.g., either of the feeders 910, 920 for a target object direction of 90°). As another example, the processor 510 may determine quantities of active antenna elements according to Equations (12)-(14), make the comparison indicated by Expression (15), and determine whether to implement inter-feeder precoding or selective-feeder based on the result of the evaluation of Expression (15). The processor 510, possibly in combination with the memory 530, may comprise means for determining the first quantity, means for determining the second quantity, and means for comparing the first quantity and the second quantity.

Also or alternatively, implementations of the method 1200 may include one or more of the following features. In an example implementation, the one or more transmit signals are transmitted from the combination of energy couplers based on a first energy coupler of the combination of energy couplers being coupled to the one or more holographic surfaces at a first location and a second energy coupler of the combination of energy couplers being coupled to the one or more holographic surfaces at a second location that is separated from the first location by a multiple of a half of a wavelength of the one or more transmit signals in the one or more holographic surfaces. For example, the processor 510 may choose to implement inter-feeder precoding based on the feeders 1010, 1020 being disposed a multiple of a half of a wavelength, in (a substrate of) the HMS 1000, apart. The one or more transmit signals may be transmitted from the combination of energy couplers based on the first location and the second location being separated from the first location by a multiple of a half of a wavelength of the one or more transmit signals in the one or more holographic surfaces with or without the combination of energy couplers corresponding to a greater quantity of active antenna elements of the plurality of antenna elements than a selected one of the plurality of energy couplers. In another example implementation, transmitting the one or more transmit signals comprises applying a respective codeword to a corresponding one of the one or more transmit signals for each of the plurality of energy couplers from which a respective one of the one or more transmit signals is emitted, a value of the respective codeword being dependent upon a location of the corresponding one of the plurality of energy couplers. For example, the precoder selection unit 560 may select the appropriate precoder(s) and cause the feeder(s) and selectively activated antenna elements to form the one or more transmit signals transmitted by the holographic surface 590 by applying the precoder(s) by multiplying the precoder(s) by the respective signal(s). The processor 510, possibly in combination with the memory 530, in combination with the transmitter 520 may comprise means for applying the respective codeword to a corresponding one of the one or more transmit signals.

### IMPLEMENTATION EXAMPLES

Implementation examples are provided in the following numbered clauses.
Clause 1. An apparatus comprising:
one or more memories;
one or more transmitters including:
   one or more holographic surfaces comprising a plurality of antenna elements;
   at least one signal source; and
   a plurality of energy couplers each coupled to one of the at least one signal source and each coupled to a respective location of the one or more holographic surfaces; and
one or more processors communicatively coupled to the one or more memories and the one or more transmitters and configured to:
   obtain a desired signal direction relative to the one or more holographic surfaces; and
   cause the one or more holographic surfaces to emit, based on the desired signal direction and a layout of the plurality of energy couplers relative to the one or more holographic surfaces, toward the desired signal direction one or more transmit signals either from a combination of energy couplers of the plurality of energy couplers, or from a selected one of the plurality of energy couplers.
Clause 2. The apparatus of clause 1, wherein the one or more processors are configured to cause the one or more holographic surfaces to emit the one or more transmit signals either from the combination of energy couplers or from the selected one of the plurality of energy couplers based on which of the combination of energy couplers or the selected one of the plurality of energy couplers corresponds to a greater quantity of active antenna elements of the plurality of antenna elements.
Clause 3. The apparatus of clause 2, wherein the one or more processors are configured to:
determine a first quantity, corresponding to the combination of energy couplers including a first energy coupler of the plurality of energy couplers and a second energy coupler of the plurality of energy couplers, of active antenna elements of the plurality of antenna elements based on a length of an array of the plurality of antenna elements, a first location of a first connection of the first energy coupler to the one or more holographic surfaces, a second location of a second connection of the second energy coupler to the one or more holographic surfaces, the desired signal direction, a first wavelength of the one or more transmit signals in free space, and a second wavelength of the one or more transmit signals in the one or more holographic surfaces;
determine a second quantity, corresponding to the selected one of the plurality of energy couplers, of active antenna elements of the plurality of antenna elements based on the length of the array of the plurality of antenna elements, the first location, the desired signal direction, the first wavelength of the one or more transmit signals in free space, and the second wavelength of the one or more transmit signals in the one or more holographic surfaces; and
compare the first quantity and the second quantity to determine whether to cause the one or more transmitters to emit the one or more transmit signals either from the combination of energy couplers or from the selected one of the plurality of energy couplers.
Clause 4. The apparatus of any of clauses 1-3, wherein the one or more processors are configured to cause the one or more holographic surfaces to emit the one or more transmit signals from the combination of energy couplers based on a first energy coupler of the combination of energy couplers being coupled to the one or more holographic surfaces at a first location and a second energy coupler of the combination of energy couplers being coupled to the one or more holographic surfaces at a second location that is separated from the first location by a multiple of a half of a wavelength of the one or more transmit signals in the one or more holographic surfaces.
Clause 5. The apparatus of any of clauses 1-4, wherein to cause the one or more holographic surfaces to emit the one or more transmit signals, the one or more processors are configured to apply a respective codeword to a corresponding one of the one or more transmit signals for each of the plurality of energy couplers from which a respective one of the one or more transmit signals is emitted, a value of the respective codeword being dependent upon a location of the corresponding one of the plurality of energy couplers.
Clause 6. A holographic surface transmission scheme selection method comprising:
obtaining, at an apparatus, a desired signal direction relative to one or more holographic surfaces, comprising a plurality of antenna elements, of the apparatus; and
transmitting, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers.
Clause 7. The holographic surface transmission scheme selection method of clause 6, wherein the one or more transmit signals is transmitted either from the combination of energy couplers or from the selected one of the plurality of energy couplers based on which of the combination of energy couplers or the selected one of the plurality of energy couplers corresponds to a greater quantity of active antenna elements of the plurality of antenna elements.
Clause 8. The holographic surface transmission scheme selection method of clause 7, further comprising:
determining a first quantity, corresponding to the combination of energy couplers including a first energy coupler of the plurality of energy couplers and a second energy coupler of the plurality of energy couplers, of active antenna elements of the plurality of antenna elements based on a length of an array of the plurality of antenna elements, a first location of a first connection of the first energy coupler to the one or more holographic surfaces, a second location of a second connection of the second energy coupler to the one or more holographic surfaces, the desired signal direction, a first wavelength of the one or more transmit signals in free space, and a second wavelength of the one or more transmit signals in the one or more holographic surfaces;
determining a second quantity, corresponding to the selected one of the plurality of energy couplers, of active antenna elements of the plurality of antenna elements based on the length of the array of the plurality of antenna elements, the first location, the desired signal direction, the first wavelength of the one or more transmit signals in free space, and the second wavelength of the one or more transmit signals in the one or more holographic surfaces; and
comparing the first quantity and the second quantity to determine whether to cause one or more transmitters of the apparatus to transmit the transmit signal either from the combination of energy couplers or from the selected one of the plurality of energy couplers.
Clause 9. The holographic surface transmission scheme selection method of any of clauses 6-8, wherein the one or more transmit signals is transmitted from the combination of energy couplers based on a first energy coupler of the combination of energy couplers being coupled to the one or more holographic surfaces at a first location and a second energy coupler of the combination of energy couplers being coupled to the one or more holographic surfaces at a second location that is separated from the first location by a multiple of a half of a wavelength of the one or more transmit signals in the one or more holographic surfaces.
Clause 10. The holographic surface transmission scheme selection method of any of clauses 6-9, wherein transmitting the one or more transmit signals comprising applying a respective codeword to a corresponding one of the one or more transmit signals for each of the plurality of energy couplers from which a respective one of the one or more transmit signals is emitted, a value of the respective codeword being dependent upon a location of the corresponding one of the plurality of energy couplers.
Clause 11. An apparatus comprising:
means for obtaining a desired signal direction relative to one or more holographic surfaces, comprising a plurality of antenna elements, of the apparatus; and
means for transmitting, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers.
Clause 12. The apparatus of clause 11, wherein the means for transmitting comprise means for transmitting the one or more transmit signals either from the combination of energy couplers or from the selected one of the plurality of energy couplers based on which of the combination of energy couplers or the selected one of the plurality of energy couplers corresponds to a greater quantity of active antenna elements of the plurality of antenna elements.
Clause 13. The apparatus of clause 12, further comprising:
means for determining a first quantity, corresponding to the combination of energy couplers including a first energy coupler of the plurality of energy couplers and a second energy coupler of the plurality of energy couplers, of active antenna elements of the plurality of antenna elements based on a length of an array of the plurality of antenna elements, a first location of a first connection of the first energy coupler to the one or more holographic surfaces, a second location of a second connection of the second energy coupler to the one or more holographic surfaces, the desired signal direction, a first wavelength of the one or more transmit signals in free space, and a second wavelength of the one or more transmit signals in the one or more holographic surfaces;
means for determining a second quantity, corresponding to the selected one of the plurality of energy couplers, of active antenna elements of the plurality of antenna elements based on the length of the array of the plurality of antenna elements, the first location, the desired signal direction, the first wavelength of the one or more transmit signals in free space, and the second wavelength of the one or more transmit signals in the one or more holographic surfaces; and
means for comparing the first quantity and the second quantity to determine whether to cause one or more transmitters of the apparatus to transmit the one or more transmit signals either from the combination of energy couplers or from the selected one of the plurality of energy couplers.
Clause 14. The apparatus of any of clauses 11-13, wherein the means for transmitting comprise means for transmitting the one or more transmit signals from the combination of energy couplers based on a first energy coupler of the combination of energy couplers being coupled to the one or more holographic surfaces at a first location and a second energy coupler of the combination of energy couplers being coupled to the one or more holographic surfaces at a second location that is separated from the first location by a multiple of a half of a wavelength of the one or more transmit signals in the one or more holographic surfaces.
Clause 15. The apparatus of any of clauses 11-14, wherein the means for transmitting the one or more transmit signals comprise means for applying a respective codeword to a corresponding one of the one or more transmit signals for each of the plurality of energy couplers from which a respective one of the one or more transmit signals is emitted, a value of the respective codeword being dependent upon a location of the corresponding one of the plurality of energy couplers.
Clause 16. A non-transitory, processor-readable storage medium comprising processor-readable instructions to cause one or more processors of an apparatus to:
obtain a desired signal direction relative to one or more holographic surfaces, comprising a plurality of antenna elements, of the apparatus; and
transmit, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers.
Clause 17. The non-transitory, processor-readable storage medium of clause 16, wherein the processor-readable instructions to cause the one or more processors to transmit the one or more transmit signals comprise processor-readable instructions to cause the one or more processors to transmit the one or more transmit signals either from the combination of energy couplers or from the selected one of the plurality of energy couplers based on which of the combination of energy couplers or the selected one of the plurality of energy couplers corresponds to a greater quantity of active antenna elements of the plurality of antenna elements.
Clause 18. The non-transitory, processor-readable storage medium of clause 17, further comprising processor-readable instructions to cause the one or more processors to:
determine a first quantity, corresponding to the combination of energy couplers including a first energy coupler of the plurality of energy couplers and a second energy coupler of the plurality of energy couplers, of active antenna elements of the plurality of antenna elements based on a length of an array of the plurality of antenna elements, a first location of a first connection of the first energy coupler to the one or more holographic surfaces, a second location of a second connection of the second energy coupler to the one or more holographic surfaces, the desired signal direction, a first wavelength of the one or more transmit signals in free space, and a second wavelength of the one or more transmit signals in the one or more holographic surfaces;
determine a second quantity, corresponding to the selected one of the plurality of energy couplers, of active antenna elements of the plurality of antenna elements based on the length of the array of the plurality of antenna elements, the first location, the desired signal direction, the first wavelength of the one or more transmit signals in free space, and the second wavelength of the one or more transmit signals in the one or more holographic surfaces; and
compare the first quantity and the second quantity to determine whether to cause one or more transmitters of the apparatus to transmit the one or more transmit signals either from the combination of energy couplers or from the selected one of the plurality of energy couplers.
Clause 19. The non-transitory, processor-readable storage medium of any of clauses 16-18, wherein the processor-readable instructions to cause the one or more processors to transmit the one or more transmit signals comprise processor-readable instructions to cause the one or more processors to transmit the one or more transmit signals from the combination of energy couplers based on a first energy coupler of the combination of energy couplers being coupled to the one or more holographic surfaces at a first location and a second energy coupler of the combination of energy couplers being coupled to the one or more holographic surfaces at a second location that is separated from the first location by a multiple of a half of a wavelength of the one or more transmit signals in the one or more holographic surfaces.
Clause 20. The non-transitory, processor-readable storage medium of any of clauses 16-19, wherein the processor-readable instructions to cause the one or more processors to transmit the one or more transmit signals comprise processor-readable instructions to cause the one or more processors to apply a respective codeword to a corresponding one of the one or more transmit signals for each of the plurality of energy couplers from which a respective one of the one or more transmit signals is emitted, a value of the respective codeword being dependent upon a location of the corresponding one of the plurality of energy couplers.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to an item in the singular (e.g., “a device,” “the device”, “a signal,” “the signal”), including in the claims, includes one or more of such devices (e.g., “a processor” includes one or more processors, “the processor” includes one or more processors, “a memory” includes one or more memories, “the memory” includes one or more memories, “a signal” includes one or more signals, “the signal” includes one or more signals, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus comprising:
one or more memories;
one or more transmitters including:
one or more holographic surfaces comprising a plurality of antenna elements;
at least one signal source; and
a plurality of energy couplers each coupled to one of the at least one signal source and each coupled to a respective location of the one or more holographic surfaces; and
one or more processors communicatively coupled to the one or more memories and the one or more transmitters and configured to:
obtain a desired signal direction relative to the one or more holographic surfaces; and
cause the one or more holographic surfaces to emit, based on the desired signal direction and a layout of the plurality of energy couplers relative to the one or more holographic surfaces, toward the desired signal direction one or more transmit signals either from a combination of energy couplers of the plurality of energy couplers, or from a selected one of the plurality of energy couplers.

2. The apparatus of claim 1, wherein the one or more processors are configured to cause the one or more holographic surfaces to emit the one or more transmit signals either from the combination of energy couplers or from the selected one of the plurality of energy couplers based on which of the combination of energy couplers or the selected one of the plurality of energy couplers corresponds to a greater quantity of active antenna elements of the plurality of antenna elements.

3. The apparatus of claim 2, wherein the one or more processors are configured to:
determine a first quantity, corresponding to the combination of energy couplers including a first energy coupler of the plurality of energy couplers and a second energy coupler of the plurality of energy couplers, of active antenna elements of the plurality of antenna elements based on a length of an array of the plurality of antenna elements, a first location of a first connection of the first energy coupler to the one or more holographic surfaces, a second location of a second connection of the second energy coupler to the one or more holographic surfaces, the desired signal direction, a first wavelength of the one or more transmit signals in free space, and a second wavelength of the one or more transmit signals in the one or more holographic surfaces;
determine a second quantity, corresponding to the selected one of the plurality of energy couplers, of active antenna elements of the plurality of antenna elements based on the length of the array of the plurality of antenna elements, the first location, the desired signal direction, the first wavelength of the one or more transmit signals in free space, and the second wavelength of the one or more transmit signals in the one or more holographic surfaces; and
compare the first quantity and the second quantity to determine whether to cause the one or more transmitters to emit the one or more transmit signals either from the combination of energy couplers or from the selected one of the plurality of energy couplers.

4. The apparatus of claim 1, wherein the one or more processors are configured to cause the one or more holographic surfaces to emit the one or more transmit signals from the combination of energy couplers based on a first energy coupler of the combination of energy couplers being coupled to the one or more holographic surfaces at a first location and a second energy coupler of the combination of energy couplers being coupled to the one or more holographic surfaces at a second location that is separated from the first location by a multiple of a half of a wavelength of the one or more transmit signals in the one or more holographic surfaces.

5. The apparatus of claim 1, wherein to cause the one or more holographic surfaces to emit the one or more transmit signals, the one or more processors are configured to apply a respective codeword to a corresponding one of the one or more transmit signals for each of the plurality of energy couplers from which a respective one of the one or more transmit signals is emitted, a value of the respective codeword being dependent upon a location of the corresponding one of the plurality of energy couplers.

6. A holographic surface transmission scheme selection method comprising:
obtaining, at an apparatus, a desired signal direction relative to one or more holographic surfaces, comprising a plurality of antenna elements, of the apparatus; and
transmitting, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers.

7. The holographic surface transmission scheme selection method of claim 6, wherein the one or more transmit signals is transmitted either from the combination of energy couplers or from the selected one of the plurality of energy couplers based on which of the combination of energy couplers or the selected one of the plurality of energy couplers corresponds to a greater quantity of active antenna elements of the plurality of antenna elements.

8. The holographic surface transmission scheme selection method of claim 7, further comprising:
determining a first quantity, corresponding to the combination of energy couplers including a first energy coupler of the plurality of energy couplers and a second energy coupler of the plurality of energy couplers, of active antenna elements of the plurality of antenna elements based on a length of an array of the plurality of antenna elements, a first location of a first connection of the first energy coupler to the one or more holographic surfaces, a second location of a second connection of the second energy coupler to the one or more holographic surfaces, the desired signal direction, a first wavelength of the one or more transmit signals in free space, and a second wavelength of the one or more transmit signals in the one or more holographic surfaces;
determining a second quantity, corresponding to the selected one of the plurality of energy couplers, of active antenna elements of the plurality of antenna elements based on the length of the array of the plurality of antenna elements, the first location, the desired signal direction, the first wavelength of the one or more transmit signals in free space, and the second wavelength of the one or more transmit signals in the one or more holographic surfaces; and
comparing the first quantity and the second quantity to determine whether to cause one or more transmitters of the apparatus to transmit the transmit signal either from the combination of energy couplers or from the selected one of the plurality of energy couplers.

9. The holographic surface transmission scheme selection method of claim 6, wherein the one or more transmit signals is transmitted from the combination of energy couplers based on a first energy coupler of the combination of energy couplers being coupled to the one or more holographic surfaces at a first location and a second energy coupler of the combination of energy couplers being coupled to the one or more holographic surfaces at a second location that is separated from the first location by a multiple of a half of a wavelength of the one or more transmit signals in the one or more holographic surfaces.

10. The holographic surface transmission scheme selection method of claim 6, wherein transmitting the one or more transmit signals comprising applying a respective codeword to a corresponding one of the one or more transmit signals for each of the plurality of energy couplers from which a respective one of the one or more transmit signals is emitted, a value of the respective codeword being dependent upon a location of the corresponding one of the plurality of energy couplers.

11. An apparatus comprising:
means for obtaining a desired signal direction relative to one or more holographic surfaces, comprising a plurality of antenna elements, of the apparatus; and
means for transmitting, based on the desired signal direction and a layout of a plurality of energy couplers relative to the one or more holographic surfaces, one or more transmit signals via the one or more holographic surfaces in the desired signal direction either from a combination of energy couplers of the plurality of energy couplers coupled to respective locations of the one or more holographic surfaces, or from a selected one of the plurality of energy couplers.

12. The apparatus of claim 11, wherein the means for transmitting comprise means for transmitting the one or more transmit signals either from the combination of energy couplers or from the selected one of the plurality of energy couplers based on which of the combination of energy couplers or the selected one of the plurality of energy couplers corresponds to a greater quantity of active antenna elements of the plurality of antenna elements.

13. The apparatus of claim 12, further comprising:
means for determining a first quantity, corresponding to the combination of energy couplers including a first energy coupler of the plurality of energy couplers and a second energy coupler of the plurality of energy couplers, of active antenna elements of the plurality of antenna elements based on a length of an array of the plurality of antenna elements, a first location of a first connection of the first energy coupler to the one or more holographic surfaces, a second location of a second connection of the second energy coupler to the one or more holographic surfaces, the desired signal direction, a first wavelength of the one or more transmit signals in free space, and a second wavelength of the one or more transmit signals in the one or more holographic surfaces;
means for determining a second quantity, corresponding to the selected one of the plurality of energy couplers, of active antenna elements of the plurality of antenna elements based on the length of the array of the plurality of antenna elements, the first location, the desired signal direction, the first wavelength of the one or more transmit signals in free space, and the second wavelength of the one or more transmit signals in the one or more holographic surfaces; and
means for comparing the first quantity and the second quantity to determine whether to cause one or more transmitters of the apparatus to transmit the one or more transmit signals either from the combination of energy couplers or from the selected one of the plurality of energy couplers.

14. The apparatus of claim 11, wherein the means for transmitting comprise means for transmitting the one or more transmit signals from the combination of energy couplers based on a first energy coupler of the combination of energy couplers being coupled to the one or more holographic surfaces at a first location and a second energy coupler of the combination of energy couplers being coupled to the one or more holographic surfaces at a second location that is separated from the first location by a multiple of a half of a wavelength of the one or more transmit signals in the one or more holographic surfaces.

15. The apparatus of claim 11, wherein the means for transmitting the one or more transmit signals comprise means for applying a respective codeword to a corresponding one of the one or more transmit signals for each of the plurality of energy couplers from which a respective one of the one or more transmit signals is emitted, a value of the respective codeword being dependent upon a location of the corresponding one of the plurality of energy couplers.

16.-20. (canceled)
